(19) United States
(12) Patent Application Publication
(10) Pub. No.: US 2025/0392856 A1
(43) Pub. Date: Dec. 25, 2025

(54) SPEAKER

(71) Applicant: AAC Microtech (Changzhou) Co., Ltd., Changzhou City (CN)

(72) Inventors: Yufen Chu, Changzhou (CN); Yao Hui, Changzhou (CN); Linxin Zhang, Changzhou (CN); Qiang Dan, Changzhou (CN)

(21) Appl. No.: 18/983,092

(22) Filed: Dec. 16, 2024

Related U.S. Application Data
(63) Continuation of application No. PCT/CN2024/100323, filed on Jun. 20, 2024.

(51) Int. Cl. H04R 1/28

(52) U.S. Cl. CPC H04R 1/2826

(57) ABSTRACT

The present disclosure discloses a speaker including at least one ultrasound unit, including: a bottom ultrasound component, a plurality of displacement assemblies. The displacement assembly includes a displacement component mounted on the bottom ultrasound component, and a resonance component. The resonance component including at least one Helmholtz resonance chamber is configured to resonate by way of vibration of the displacement component for changing a volume of each of the at least one Helmholtz resonance chamber. An ultrasonic signal emitted by the bottom ultrasound component is demodulated to a low frequency signal in the at least one Helmholtz resonance chamber. The low frequency signal is transmitted to outside through the sound output channel.

### FIELD OF THE PRESENT DISCLOSURE

The present disclosure relates to electric-acoustic conversion technologies, especially relates to a speaker.

### DESCRIPTION OF RELATED ART

Based on the principle of parametric array, the directional speaker modulates the audio signal onto the ultrasonic carrier to produce highly directional audible sound through the self-demodulation process under nonlinear action.

In related art, the ultrasound component of a conventional speaker generates audible sound based on specific modulated signal through the self-demodulation process of the ultrasound under nonlinear action. However, due to the low demodulation efficiency and large size, the speaker in related art cannot be applied in electronic portable mobile terminals.

Therefore, it is necessary to provide an improved speaker to overcome the problems mentioned above.

### SUMMARY OF THE INVENTION

One object of the present disclosure is to provide a speaker realizing ultrasonic demodulation by Helmholtz resonator, and having higher demodulation efficiency and smaller size.

The speaker includes at least one ultrasound unit, including: a bottom ultrasound component; a plurality of displacement assemblies arranged along a periphery of the bottom ultrasound component, configured to enclose a sound output channel with the bottom ultrasound component, comprising: a displacement component mounted on the bottom ultrasound component; and a resonance component mounted on a side of the displacement component away from the bottom ultrasound component; wherein the resonance component includes at least one Helmholtz resonance chamber connected with the sound output channel; the resonance component is configured to resonate by way of vibration of the displacement component for changing a volume of each of the at least one Helmholtz resonance chamber; an ultrasonic signal emitted by the bottom ultrasound component is demodulated to a low frequency signal in the at least one Helmholtz resonance chamber; the low frequency signal is transmitted to outside through the sound output channel.

As an improvement, a resonance frequency of the displacement component is equal to a resonance frequency of air in the at least one Helmholtz resonance chamber.

As an improvement, a resonance frequency of the displacement component is equal to a resonance frequency of the bottom ultrasound component.

As an improvement, the displacement component is made of piezoelectric material.

As an improvement, a carrier frequency of the ultrasonic signal emitted by the bottom ultrasound component is greater than or equal to 100 kHz.

As an improvement, the bottom ultrasound component is rectangular; an amount of the plurality of displacement assemblies is four; each of the four displacement assemblies is arranged along a respective one of four edges of the bottom ultrasound component.

As an improvement, an amount of the at least one Helmholtz resonance chamber is three; the three Helmholtz resonance chambers are arranged at intervals along a direction parallel to the sound output channel.

As an improvement, the bottom ultrasound component includes a main body and a protrusion extending from the main body towards the sound output channel; the displacement component is mounted on the protrusion.

As an improvement, the protrusion includes a base and a groove depressed from the base along a direction away from the sound output channel; the displacement component is mounted on the base.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

FIG. 1 is an isometric view of a speaker in accordance with an exemplary embodiment of the present disclosure.

FIG. 2 is an isometric view of an ultrasound unit of the speaker in FIG. 1.

FIG. 3 is an exploded view of the ultrasound unit in FIG. 2.

FIG. 4 is a cross-sectional view of the ultrasound unit taken along line A-A in FIG. 2.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

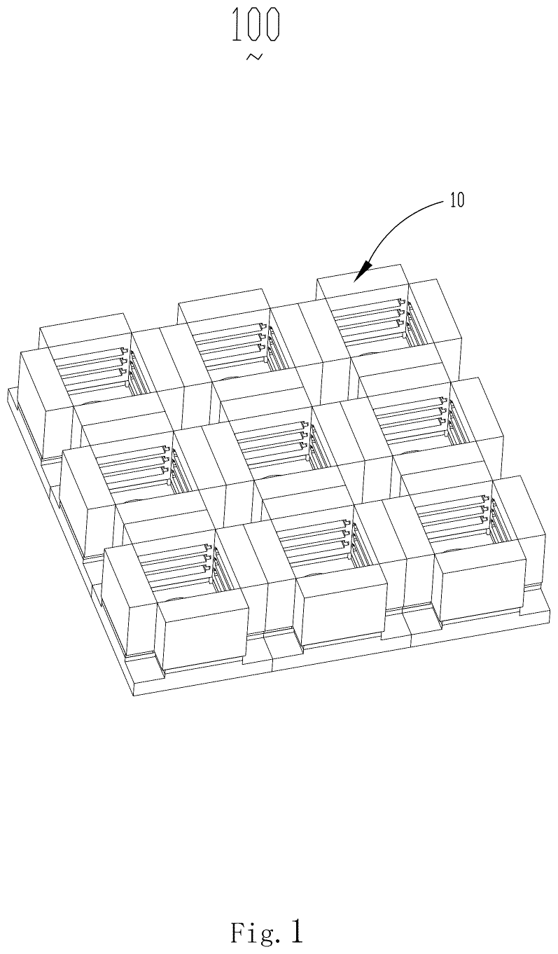

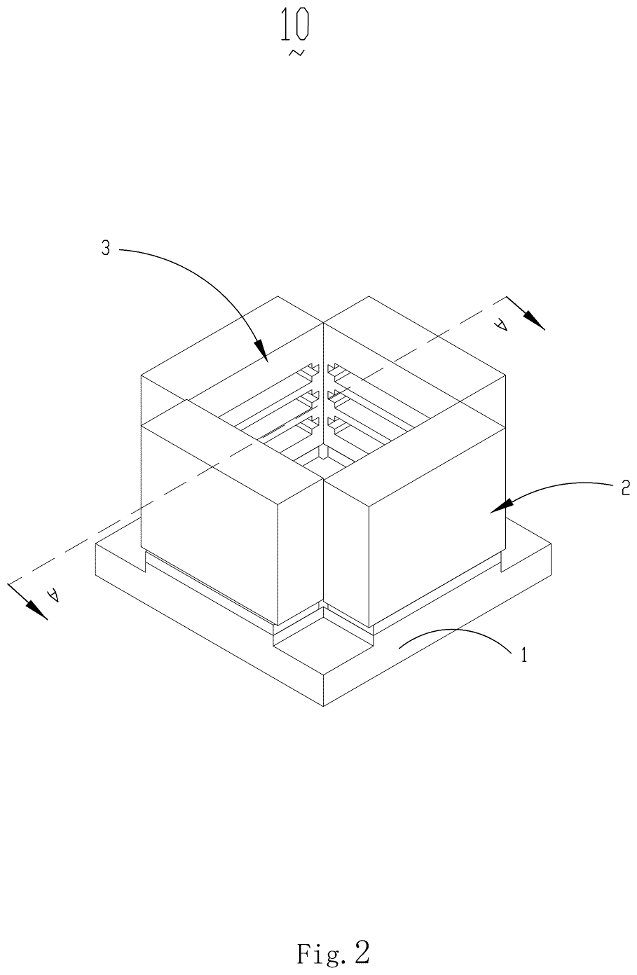

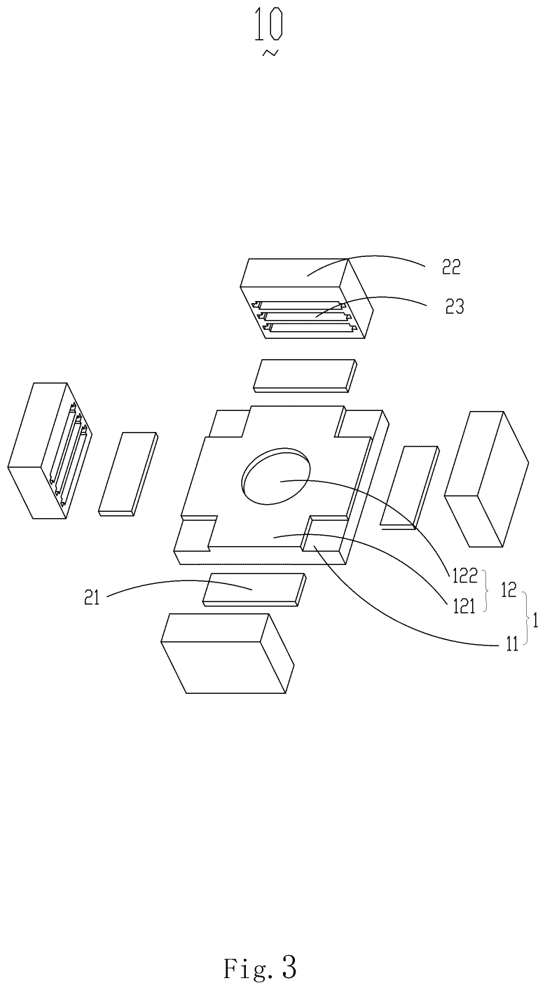

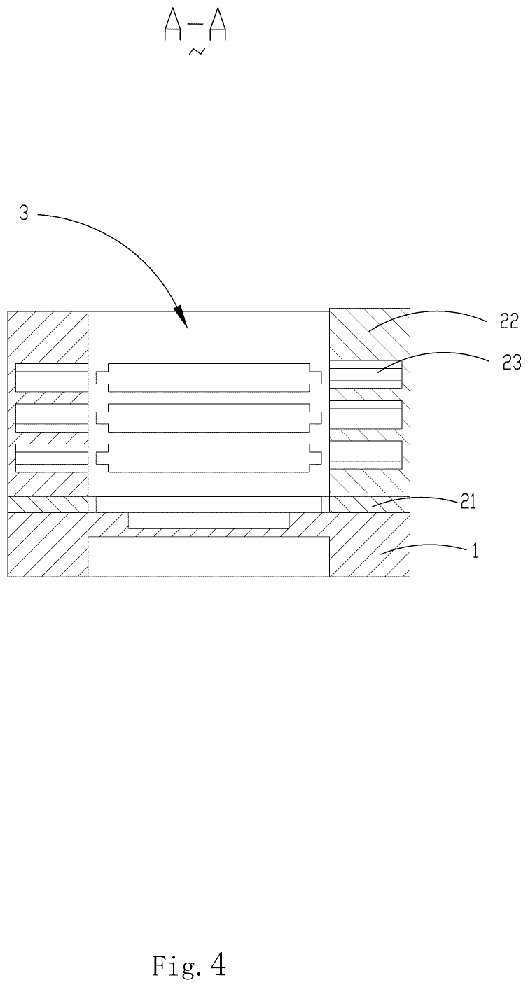

Please refer to FIGS. 1-4 together, a speaker 100 provided by an exemplary embodiment of the present disclosure includes at least one ultrasound unit 10. The ultrasound unit 10 includes a bottom ultrasound component 1 and a plurality of displacement assemblies 2 arranged along a periphery of the bottom ultrasound component 1. A sound output channel 3 is enclosed by the bottom ultrasound component 1 and the plurality of displacement assemblies 2.

Each of the plurality of displacement assemblies 2 includes a displacement component 21 mounted on the bottom ultrasound component 1, and a resonance component 22 mounted on a side of the displacement component 21 away from the bottom ultrasound component 1. The resonance component 22 includes at least one Helmholtz resonance chamber 23 connected with the sound output channel 3. The resonance component 22 is configured to resonate by way of vibration of the displacement component 21 for changing a volume of the at least one Helmholtz resonance chamber 23. An ultrasonic signal emitted by the bottom ultrasound component 1 is demodulated to a low frequency signal in the at least one Helmholtz resonance chamber 2. The low frequency signal is transmitted to outside through the sound output channel 3.

Specifically, a motivation signal is applied on the displacement component 21 to drive its vibration, thus providing a harmonic force for driving the resonance component 22. Along with the harmonic force, the resonance component 22 resonates to shrink, thereby changing the volume of each of the at least one Helmholtz resonance chamber 2. A displacement of a portion of the resonance component 22 increases along a direction towards the bottom ultrasound component 1. The displacement of a portion of the resonance component 22 closer to the displacement component 21 is the greater than the displacement of a portion of the resonance component 22 away from the displacement component 21.

Furthermore, owing to the volume change of the at least one Helmholtz resonance chamber 23, a resonance frequency of the resonance component 22 is equal to a resonance frequency of air in the at least one Helmholtz resonance chamber 23. Therefore, the ultrasonic signal emitted by the bottom ultrasound component 11 is demodulated to a low frequency signal in the at least one Helmholtz resonance chamber 23. And then, the low frequency signal is transmitted to outside through the sound output channel 3. In particular, by adjusting the volume of the at least one Helmholtz resonance chamber 23, the harmonic change the sound pressure amplitude of the ultrasonic signal is resulted, thus demodulating the low frequency information of the ultrasonic signal into the low frequency signal. The low frequency signal can be obtained by human.

In one embodiment, a resonance frequency of the displacement component 21 is equal to a resonance frequency of the bottom ultrasound component 1.

Specifically, the ultrasonic signal is an ultrasonic modulation signal. Optionally, the ultrasonic signal emitted by the bottom ultrasound component 1 can be obtained through various modulation methods, such as DSB (Double Sideband Signal), DSB-SC (Double Sideband with Suppressed Carrier), SSB (Single Sideband Signal). The motivation signal driving the displacement component 21 is a single frequency ultrasonic signal. According to the signal modulation and demodulation mechanism, the ultrasonic modulation signal emitted by the bottom ultrasound component 1 is multiplied by the single frequency ultrasonic signal, thus demodulating the low frequency information of the ultrasonic modulation signal emitted by the bottom ultrasound component 1.

It should be understood that the resonance frequency and the size of the of the at least one Helmholtz resonance chamber 23 could be adjusted according to various design as long as the change of the sound pressure amplitude of the ultrasonic signal emitted by the bottom ultrasonic component 1 for demodulation could be resulted.

In one embodiment, the displacement component 21 is made of piezoelectric material. When the displacement component 21 is activated by the motivation signal, the displacement component 21 vibrates along an extension direction of the sound channel 3 to generate displacement, thus causing the resonance of the resonance component 22.

In one embodiment, a carrier frequency of the ultrasonic signal emitted by the bottom ultrasound component 1 is greater than or equal to 100 kHz. An MEMS ultrasonic component could be provided as the bottom ultrasound component 1.

The bottom ultrasound component 1 is rectangular. An amount of the plurality of displacement assemblies 2 is four. Each of the four displacement assemblies 2 is arranged along a respective one of four edges of the bottom ultrasound component 1.

An amount of the at least one Helmholtz resonance chamber 23 is three. The three Helmholtz resonance chambers 23 are arranged at intervals along a direction parallel to the sound output channel 3, which is the extension direction of the sound output channel 3.

Concretely, the bottom ultrasound component 1 includes a main body 11 and a protrusion 12 extending from the main body 11 towards the sound output channel 3. The displacement component 21 is mounted on the protrusion 12. Furthermore, the protrusion 12 includes a base 121 and a groove 122 depressed from the base 121 along a direction away from the sound output channel 3. The displacement component 21 is mounted on the base 121. The groove 122 is arranged opposite to the sound output channel 3.

Compared with the related art, the speaker in the present disclosure has smaller size and higher electrical-acoustic conversion efficiency.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker comprising:
at least one ultrasound unit, comprising:
a bottom ultrasound component;
a plurality of displacement assemblies arranged along a periphery of the bottom ultrasound component, configured to enclose a sound output channel with the bottom ultrasound component, comprising:
a displacement component mounted on the bottom ultrasound component; and
a resonance component mounted on a side of the displacement component away from the bottom ultrasound component; wherein the resonance component comprises at least one Helmholtz resonance chamber connected with the sound output channel;
the resonance component is configured to resonate by way of vibration of the displacement component for changing a volume of each of the at least one Helmholtz resonance chamber;
an ultrasonic signal emitted by the bottom ultrasound component is demodulated to a low frequency signal in the at least one Helmholtz resonance chamber; the low frequency signal is transmitted to outside through the sound output channel.

2. The speaker as described in claim 1, wherein a resonance frequency of the displacement component is equal to a resonance frequency of air in the at least one Helmholtz resonance chamber.

3. The speaker as described in claim 1, wherein a resonance frequency of the displacement component is equal to a resonance frequency of the bottom ultrasound component.

4. The speaker as described in claim 1, wherein the displacement component is made of piezoelectric material.

5. The speaker as described in claim 1, wherein a carrier frequency of the ultrasonic signal emitted by the bottom ultrasound component is greater than or equal to 100 kHz.

6. The speaker as described in claim 1, wherein the bottom ultrasound component is rectangular; an amount of the plurality of displacement assemblies is four; each of the four displacement assemblies is arranged along a respective one of four edges of the bottom ultrasound component.

7. The speaker as described in claim 1, wherein an amount of the at least one Helmholtz resonance chamber is three; the three Helmholtz resonance chambers are arranged at intervals along a direction parallel to the sound output channel.

8. The speaker as described in claim 1, wherein the bottom ultrasound component comprises a main body and a protrusion extending from the main body towards the sound output channel; the displacement component is mounted on the protrusion.

9. The speaker as described in claim 8, wherein the protrusion comprises a base and a groove depressed from the base along a direction away from the sound output channel; the displacement component is mounted on the base.
